(19) United States
(12) Patent Application Publication
(10) Pub. No.: US 2008/0250220 A1
(43) Pub. Date: Oct. 9, 2008

(54) MEMORY SYSTEM

(76) Inventor: Takafumi ITO, Ome-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/062,060

(22) Filed: Apr. 3, 2008

(30) Foreign Application Priority Data
Apr. 6, 2007 (JP) 2007-100675
Dec. 19, 2007 (JP) 2007-327814

(51) Int. Cl. G06F 12/00

(52) U.S. Cl. 711/173; 711/E12.001

(57) ABSTRACT

In a memory system according to an aspect of the invention, a nonvolatile semiconductor memory includes storage areas each composed of a group of storage elements, stores one or more than one bit of data into each of the storage elements and selects either a first write mode in which n bits or a second write mode in which n+1 bits are stored into each of the storage elements. A controller instructs the semiconductor memory to store data, for each of logical address groups each composed of logical addresses belonging to a specific range, by writing a part of the data allocated with the logical addresses included in the logical address group into a first number of the storage areas in the first write mode and writing another part of the data into a second number of the storage areas in the second write mode.

### CROSS-REFERENCE TO RELATED APPLICATIONS

This application is based upon and claims the benefit of priority from prior Japanese Patent Applications No. 2007-100675, filed Apr. 6, 2007; and No. 2007-327814, filed Dec. 19, 2007, the entire contents of both of which are incorporated herein by reference.

### BACKGROUND OF THE INVENTION

1. Field of the Invention

This invention relates to a memory system, and more particularly to a memory card which includes, for example, a NAND flash memory and a controller for controlling the flash memory.

2. Description of the Related Art

In recent years, memory systems which use a memory cards have been used as music or video data recording media.

For some memory cards, a speed class standard is defined. Speed class guarantees that the data in a specific range of logical addresses of a card belonging to a certain speed class can be written into a card belonging to a speed class at a speed determined according to the class. A group of the logical address in the specific range used in defining a speed class is termed as an allocation unit (AU). The size of the AU conforming to a certain standard is, for example, 4 MB.

According to a certain standard, a memory card belonging to class 2 has to guarantee a write speed of 2 MB/s or more for each AU. A memory card belonging to class 4 has to guarantee a write speed of 4 MB/s or more for each AU. A memory card belonging to class 6 has to guarantee a write speed of 6 MB/s or more for each AU.

In the memory cards, as a flash memory, a multilevel NAND flash memory (hereinafter, referred to as a multilevel memory), has recently been often used. In the multilevel memory, writing operation is done in unit called pages each composed of a plurality of bits. Erasing operation is done in unit called physical blocks (erase blocks) each composed of a plurality of pages.

A multilevel memory is so configured that a memory cell can store, for example, 2 levels of data (“0”, “1”) and 4 levels (“0”, “1”, “2”, “3”) of data (or more than 4 levels of data). Whether data is written using 2 levels of data (2-level mode) or 4 levels of data (4-level mode) can usually be selected in each physical block.

When data is written into a physical block using the 4-level mode, the write speed is lower than that when writing operation is done using the 2-level mode, although the storage capacity per memory cell is greater than when the 2-level mode are used. The reason is that writing operation in the 4-level mode is more complicated and delicate in control than writing operation in the 2-level mode. Conversely, although writing operation in the 2-level mode can be completed at a higher speed than that in the 4-level mode, the storage capacity per memory cell is smaller.

Specifically, for example, in a multilevel memory, when a physical block is written into in the 4-level mode, its storage capacity is as large as 512 KB, but its write speed (the worst one of the average values in each of a plurality of physical blocks for a certain value) is as low as 5 MB/s. On the other hand, when writing operation is done in the 2-level mode, its capacity is as small as 256 KB, but its write speed is as high as 16 MB/s. The write speed, which depends on the performance of the NAND flash memory, is inherent to the memory, and remains unchanged.

Consider a case where a memory card belonging to a certain speed class is configured using a multilevel memory in which 4 k physical blocks can be used to store data and which has the above-described characteristics. If all of the usable physical blocks are written into in the 2-level mode, the memory card can achieve the write speed required in class 2, but only a 1-GB storage capacity can be realized. On the other hand, if all of the usable physical blocks are written into in the 4-level mode to achieve a greater storage capacity, a 2-GB storage capacity can be realized, but the write speed required in class 6 is not reached and therefore the memory card is categorized as class 4.

As described above, when a memory card is configured using a multilevel memory with its inherent performance, a high storage capacity is incompatible with a high write speed.

### BRIEF SUMMARY OF THE INVENTION

According to an aspect of the invention, there is provided a memory system comprising: a nonvolatile semiconductor memory which includes a plurality of storage areas each composed of a group of a plurality of storage elements, stores one or more than one bit of data into each of the plurality of storage elements and selects either a first write mode in which n (n is a natural number) bits of data are stored into each of the plurality of storage elements or a second write mode in which n+1 or more bits of data are stored into each of the plurality of storage elements for each of the plurality of storage areas; and a controller which instructs the nonvolatile semiconductor memory to store data, for each of a plurality of logical address groups each composed of a plurality of logical addresses belonging to a specific range, by writing a part of the data allocated with the logical addresses included in the logical address group into a preset first number of the plurality of storage areas in the first write mode and writing another part of the data into a preset second number of storage areas in the plurality of storage areas in the second write mode.

According to another aspect of the invention, there is provided a memory system comprising: a nonvolatile semiconductor memory which includes a plurality of storage areas each composed of a group of a plurality of storage elements, stores one or more than one bit of data into each of the plurality of storage elements and selects either a first write mode in which n (n is a natural number) bits of data are stored into each of the plurality of storage elements or a second write mode in which n+1 or more bits of data are stored into each of the plurality of storage elements for each of the plurality of storage areas; and a controller which instructs the nonvolatile semiconductor memory to store data, for each of a plurality of logical address groups each composed of a plurality of logical addresses belonging to a specific range, by writing a part of the data allocated with the logical addresses included in the logical address group into a preset first number of the plurality of storage areas in the first write mode and writing another part of the data into a preset second number of the plurality of storage areas in the second write mode, wherein a first logical area with a first storage capacity and a second logical area with a second storage capacity are set, and the plurality of storage areas are allocated to the logical address group in the first logical area and the logical address group in the second logical area in such a manner that the first number or the second number differs between the logical address group in the first logical area and that in the second logical area.

### BRIEF DESCRIPTION OF THE SEVERAL VIEWS OF THE DRAWING

FIG. 1 is a functional block diagram of a memory system according to an embodiment of the invention and a host unit;

FIG. 2 shows the configuration of a memory space;

FIG. 3 is a diagram to explain the difference between the 2-level mode and the multilevel mode;

FIG. 4 shows the correspondence between the physical blocks and the write modes set in the physical blocks;

FIG. 5 shows a concrete example of the correspondence between the physical blocks and the write modes set in the physical blocks;

FIG. 6 shows a configuration for setting the class of the memory system;

FIG. 7 shows the correspondence between the partitions and the write modes set in the physical blocks; and

FIG. 8 shows a concrete example of the correspondence between the partitions and the write modes set in the physical blocks.

### DETAILED DESCRIPTION OF THE INVENTION

Hereinafter, referring to the accompanying drawings, embodiments of the invention will be explained. In the explanation below, the component parts which have basically the same functions and configurations are indicated by the same reference numerals. A repeated explanation will be given only when necessary.

### First Embodiment

[1] Configuration

[1-1] Overall Configuration

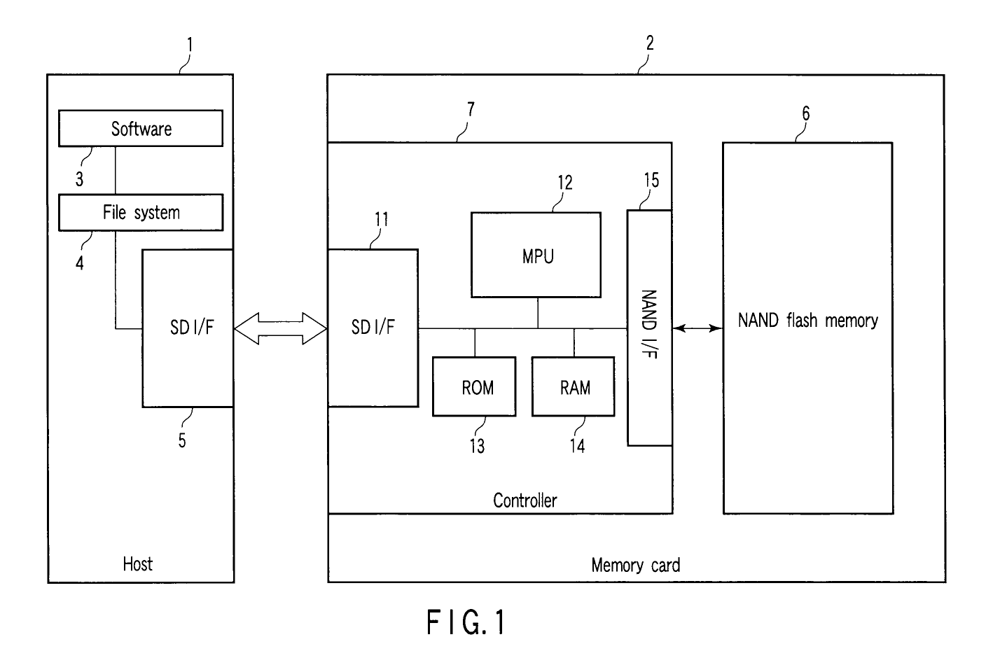

FIG. 1 is a functional block diagram schematically showing the main part of a memory system according to a first embodiment of the invention and a host unit. Each functional block can be realized by either hardware or computer software or by combining them. To make it clear that each block can be realized by both approaches, the individual blocks will be explained chiefly from the viewpoint of their functions. Whether such functions are realized in hardware or software depends on concrete embodiments or the design constraint imposed on the system as a whole. Those skilled in the art can realize those functions by various methods in each embodiment of the invention. Any method of realizing the functions is in the scope of the invention.

In FIG. 1, a host unit (hereinafter, referred to as a host) 1 includes hardware and software for accessing a memory card 2 to be inserted. The host 1 includes software 3, including applications and an operation system. The user instructs the software 3 to write data into the memory card 2 or read the data from the memory card 2. The software 3 instructs a file system 4 to read and write data.

The file system 4, which is a mechanism for managing the files (data) recorded on a recording medium to be managed, records management information in a storage area of the recording medium and manages the files using the management information. In the file system 4, the following have been determined: a method of creating directory information including files and folders in the storage medium, a method of moving and erasing files or folders, a method of recording data, the location of an area in which the management information has been recorded, a method of using the management information, and others.

The host 1 has an SD interface 5. The SD interface 5 is composed of hardware and software necessary to provide an interface between the host 1 and the memory card 2 (controller 7). The host 1 communicates with the memory card 2 via the SD interface 5. The SD interface 5, which determines various rules necessary for the host 1 and memory card 2 to communicate with each other, includes a group of various commands an SD interface 11 of the memory card 2 explained later can also recognize. Moreover, the SD interface 5 includes a hardware configuration (including the pin arrangement and the number of pins) connectable to the SD interface 11 of the memory card 2.

When the memory card 2 is connected to the host 1 or when the card 2 is inserted in the host 1 in the off state and then the host 1 is turned on, the memory card 2 receives a power supply and performs initial operation and thereafter carries out a process according to the access from the host 1. The memory card 2 has a NAND flash memory and a controller 7 for controlling the memory 6.

The memory 6, which stores data in a nonvolatile manner, writes and reads data in units called pages each composed of a plurality of memory cells. A unique physical address is allocated to each page. The memory 6 erases data in units called physical blocks each composed of a plurality of pages. Physical addresses may be allocated in physical blocks.

The controller 7 manages the data storage state in the memory 6. The management of the storage state includes the management of information as to what physical address page (or physical block) holds which logical address data allocated by the host 1 and of information as to what physical address page (or physical block) is in the erased state (the state where nothing has been written or invalid data has been held).

The controller 7 includes the SD interface 11, a micro processing unit (MPU) 12, a read-only memory (ROM) 13, a random access memory (RAM) 14, and a NAND interface 15.

The SD interface 11 is composed of hardware and software necessary to provide an interface between the host 1 and the controller 7. The memory card 2 (controller 6) communicates with the host 1 via the SD interface 11. Like the SD interface 5, the SD interface 11 has determined rules for enabling the host 1 and memory card 2 to communicate with each other and includes a group of various commands. Moreover, the SD interface 11 includes a hardware configuration (including the pin arrangement and the number of pins).

The MPU 12 supervises the entire operation of the memory card 2. For example, when the memory card 2 has received a power supply, the MPU 12 reads the firmware (control program) stored in the ROM 13 onto the RAM 14 and carries out a specific process. According to the control program, the MPU 12 creates various tables (explained later) on the RAM 14 or receives a write command, a read command, or an erase command from the host 1 and performs a specific process on the memory 6.

The ROM 13 stores a control program controlled by the MPU 12 and other data. The RAM 14, which is used as a work area of the MPU 12, temporarily stores the control program and various tables. The tables include a conversion table (logical-physical table) for the physical address of a page which actually stores the data allocated the logical address by the file system 4. The NAND interface 15 provides an interface between the controller 7 and memory 6.

The storage area of the memory 6 is divided into a plurality of areas from a functional viewpoint according to the type of data to be stored. The plurality of areas include, for example, a system data area, a confidential data area, a protected data area, and a user data area.

The system data area is an area secured by the controller 7 in the memory 6 to store the necessary data for its operation. The confidential data area stores key information used for encryption and confidential data used for authentication. The host 1 cannot access the confidential data area. The protected data area stores important data and secure data.

The user data area stores user data, including, for example, AV content files and image data. The host 1 can access the user data area freely. In the explanation below, the memory 6 is referred to as the user data area. The controller 7 secures a part of the user data area and stores the necessary control data (including a logic-physical table) for its operation.

[1-2] Configuration of Memory

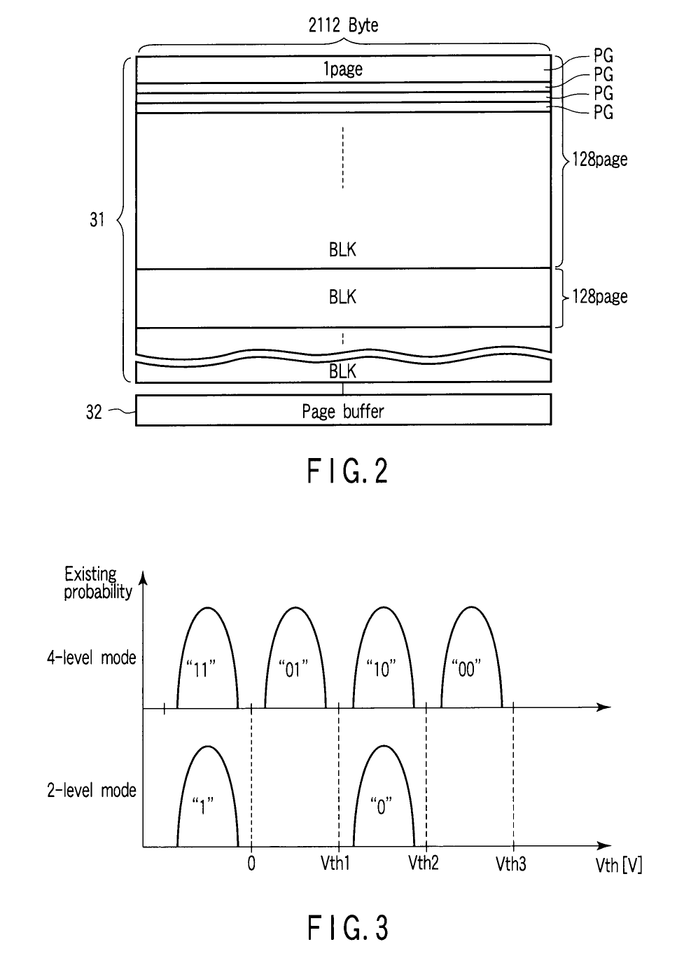

Next, the configuration of the memory will be explained using FIGS. 2 and 3.

[1-2-1] Physical Configuration of the Memory Space and Memory

First, using FIG. 2, the configuration of the memory space of the memory 6 will be explained. FIG. 2 shows the configuration of the memory space of the memory 6.

As shown in FIG. 2, the memory 6 includes an ordinary memory area 31 and a page buffer 32.

The memory area 31 includes a plurality of physical blocks BLK. Each of the physical blocks BLK is composed of a plurality of pages PG. Each of the pages PG includes a plurality of memory cell transistors connected in series.

Each of the memory cells is composed of a so-called stacked-gate metal-oxide semiconductor field-effect transistor (MOSFET). The stacked-gate MOSFET includes a tunnel insulating film, a floating gate electrode, an interelectrode insulating film, a control gate electrode, and a source/drain diffused layer. In each of the memory cell transistors, its threshold voltage varies according to the number of electrons stored at the floating gate electrode. The memory cell transistor stores information corresponding to the difference in threshold voltage. The memory cell transistor can take two or more states differing in threshold voltage. That is, each of the memory cell transistors is configured to be capable of storing multilevel data (or multibit data). A control circuit which includes a sense amplifier for the memory 6 and a potential generator circuit is configured to be capable of writing or reading multibit data into or from a memory cell transistor.

The control gate electrodes of the memory cell transistors belonging to the same row are connected to the same word line. A select gate transistor is provided on either side of the memory cell transistors belonging to the same column and being connected in series. One select gate transistor is connected to a bit line. Under this rule, the memory cell transistors, select gate transistors, word lines, and bit lines are provided. Data is written and read in units of a set of memory cell transistors. A storage area composed of a set of memory cell transistors corresponds to one page.

In the example of FIG. 2, each page PG contains 2112 B (512-B data storage unit×4+10-B redundant unit×4+a 24-B management data storage unit). Each physical block BLK is composed of, for example, 128 pages.

The page buffer 32, which inputs and outputs data to and from the memory 6, temporarily holds data. The size of data the page buffer 32 can hold is, for example, 2112 B (2048 B+64 B), the same size as that of the page PG. When writing data, the page buffer 32 inputs or outputs data to or from the memory 6 in units of one page corresponding to its storage capacity. The erasing operation is done in units of a physical block BLK.

The memory 6 has a mode in which one bit of data can be written into a memory cell transistor and a mode in which multibit data, that is, 2ⁿ (n is a natural number) levels of data into a memory cell transistor. The mode in which the memory 6 writes one bit of data into a memory cell transistor is referred to as the 2-level mode. The mode in which the memory 6 writes multibit data is referred to as the multilevel mode (or specifically, for example, the 4-level mode or 8-level mode).

[1-2-2] Memory Write Mode

Next, using FIG. 3, the 2-level mode and multilevel mode will be explained. FIG. 3 is a diagram to explain the difference between the 2-level mode and multilevel mode. As described above, each of the memory cell transistors of the memory 6 can store 2 or more bits of data. That is, each memory cell transistor stores 2ⁿ (n is a natural number) levels of data. In the explanation below, as an example of the multilevel mode, the 4-level mode will be explained. In FIG. 3, the abscissa axis indicates a threshold voltage Vth and the ordinate axis indicates the existing probability of memory cells.

First, the 4-level mode will be explained. As shown in FIG. 3, a memory cell transistor can store any one of the four items of data, for example, “11” (“3”), “01” (“2”), “10” (“1”), “00” (“0”) in increasing order of threshold voltage according to the magnitude of the threshold voltage Vth. The threshold voltage Vth [V] of the memory cell transistor that stores data “11” satisfies the expression Vth<0. The threshold voltage Vth [V] of the memory cell transistor that stores data “01” satisfies the expression 0<Vth<Vth1. The threshold voltage Vth [V] of the memory cell transistor that stores data “10” satisfies the expression Vth1<Vth<Vth2. The threshold voltage Vth [V] of the memory cell transistor that stores data “00” satisfies the expression Vth2<Vth<Vth3.

Next, the 2-level mode will be explained. As shown in FIG. 3, a memory cell transistor can store either of the two items of data, for example, “1” and “0” in increasing order of threshold voltage according to the magnitude of the threshold voltage Vth. The threshold voltage Vth [V] of the memory cell transistor that stores data “1” satisfies the expression Vth<0. The threshold voltage Vth [V] of the memory cell transistor that stores data “0” satisfies the expression Vth1<Vth<Vth2.

Data “1” is equal to data “11” in the 4-level mode. Data “0” has the same threshold voltage as that of data “10” in the 4-level mode. That is, it can be said that the 2-level mode is an operation mode in which only lower bits in the 2-bit data are used in the 4-level mode. Whether the memory 6 writes data into the memory cell transistor in the 2-level mode or the 4-level mode is determined according to the instruction given by the controller 7. Specifically, a lower page address is allocated to a lower bit in the 2-bit data and an upper page address is allocated to a higher bit. When data is written into a memory cell transistor in the 2-level mode, the controller 7 writes data into the memory, using only a lower one of the page addresses. When data is written into the memory cell transistor in the multilevel mode, the controller 7 writes data into the memory 6, using both an upper page address and a lower page address.

Data is written, beginning with a lower bit. If the erased state is “11,” “0” or “1” is written into a lower bit, causing the memory cell transistor to go into a state where it holds “11” (“−1”) or “10” (“−0”). Here, “−” means indefinite. In the 2-level mode, with that, the write operation ends.

On the other hand, when writing operation is done in the 4-level mode, “0” or “1” is further written into a higher bit. As a result, the memory cell transistor that holds “11” (“−1”) goes into a state where it holds “11” or “01” and the memory cell transistor that holds “10” (“−0”) goes into a state where it holds “10” or “00”. The same holds true for the 8-level mode, the 16-level mode, and other modes.

In the multilevel mode, although the data storage amount per memory cell is large, the write speed is low. On the other hand, in the 2-level mode, although the data storage amount per memory cell is small, the write speed is high and the resistance to the frequency of rewriting is high.

The memory 6 can select writing in either the 2-level mode or multilevel mode on a physical block basis.

Not only the 4-level mode but also an 8-level mode (3 bits per memory cell) or a 16-level mode (4 bits per memory cell) can be considered. In any case, the smaller the number of bits per memory cell, the higher the write speed and the higher the resistance to the frequency of writing.

[2] Operation

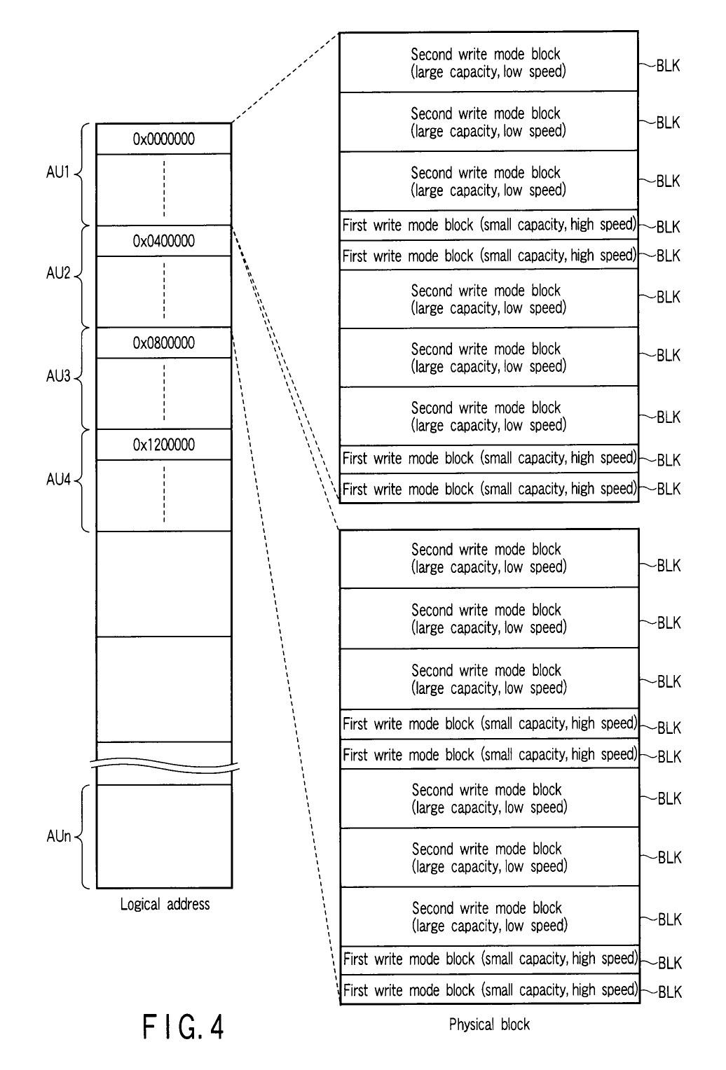

Next, the write operation of the memory card 2 will be explained with reference to FIG. 4. FIG. 4 shows an example of the correspondence between the physical blocks and the write methods (write modes) set in the individual physical blocks.

As shown in FIG. 4, the file system 4 divides the write data into items of data of a specific size and manages them. When the file system 4 is a FAT file system, data of the specific size is referred to as a cluster. The size of a cluster is, for example, 16K bytes. Each of the clusters is assigned a unique logical address.

Furthermore, a unit AU composed of a specific number of logical addresses has been defined. The AU is a group of logical address (logical address group) used to determine the speed class of a memory card. A memory card belonging to a certain speed class is required to have an AU data write speed greater than or equal to a specific value. According to a certain standard, the AU corresponds to consecutive logical addresses corresponding to 4 MB of data. Hereinafter, the explanation will be given using a 4-MB AU as an example. In the description below, the worst one of the average values of the write speeds in a suitable number of AUs is used as the write speed.

Receiving the data write request from the host 1, the memory card 2 allocates one AU as many unused (data-erased) physical blocks as can store data whose size is the same as that of one AU. In the allocation, the number of physical blocks allocated to one AU has been determined in accordance with the rule described below.

In the first embodiment, when a plurality of physical blocks allocated to store the data in each AU are written into, at least two write modes are used. In one write mode, a large storage capacity can be realized, but the write speed is low. In the other write mode, the storage capacity is small, but the write speed is high. The mixing ratio of the write modes is set in advance so that the data in one AU can be covered by as few physical blocks as possible, while the average write speed of the data in one AU is achieving the desired speed. A more detailed explanation will be given below.

First, suppose the memory 6 can write data in physical blocks in at least one of a first write mode and a second write mode. The first write mode is a mode in which writing operation can be done at a speed of WP1 and the second write mode is a mode in which writing operation is done at a speed of WP2. The speed WP1 and speed WP2 satisfy the following expression: WP1>WP2.

The storage capacity of a physical block written into in the first write mode is C1. The storage capacity of a physical block written into in the second write mode is C2. The storage capacity C1 and storage capacity C2 fulfill the following expression: C1<C2. Let the storage capacity required to store the data in one AU be CAU.

The controller 7 writes data into a part of a plurality of physical blocks allocated to one AU in the first mode and the remaining part in the second mode. Hereinafter, a physical block written into in the first write mode is referred to as a first write mode block and a physical block written into in the second write mode is referred to as a second write mode block. The number B1 of first write mode blocks and the number B2 of second write mode blocks have to be values which enable the first and second write mode blocks to deal with a capacity greater than or equal to that of one AU. That is, the number B1 and number B2 have to satisfy the following expression (1):

C1×B1+C2×B2≧CAU (1)

where C1: the storage capacity of a first write mode block
C2: the storage capacity of a second write mode block
CAU: the storage capacity required to store the data in one AU
B1: the number of first write mode blocks
B2: the number of second write mode blocks

If the number of second write mode blocks is increased in the range which satisfies expression 1, the number of physical blocks required to store the data in one AU can be reduced. On the other hand, as the number of second write mode blocks increases, the write speed of the data in one AU decreases.

When the number of first write mode blocks and that of second write mode blocks are set suitably, the storage capacity of the memory 6 can be increased, while the write speed required by a desired speed class is being achieved. Hereinafter, this method will be explained. Although not explicitly shown, the explanation below is based on the assumption that expression 1 is satisfied.

First, a condition to achieve the write speed required by the desired speed class will be explained. Suppose the target average speed required to write the data belonging to one AU into the memory 6 is speed WP3. The average speed by parallel use of the first and second write modes is requested to be equal to or higher than speed WP3. That is, the following expression (2) has to be satisfied:

CAU/{(C1/WP1)×B1+(C2/WP2)×B2}≧WP3 (2)

where WP1: the write speed in the first write mode
WP2: the write speed in the second write mode

Expression 2 may be represented as the following expression (3):

(C1/WP1)×B1+(C2/WP2)×B2≦H (3)

where H is the time required for the memory system 2 to write the data in one AU of a certain size needed to belong to a target speed class. H is expressed as H=CAU/WP3. That is, when the number of first write blocks and that of the second write blocks are B1 and B2, respectively, the time required to write the data in one AU has to be shorter than the time required to write the data in one AU at the speed required by the target speed class.

The number B1 of first write mode blocks and the number B2 of second write mode blocks are determined so as to satisfy expression 2 (or 3), thereby achieving the target write speed.

If the number B1 of first write mode blocks is increased in the range which satisfies expression 2, the storage capacity of the memory 6 can be increased, while the target write speed is being achieved.

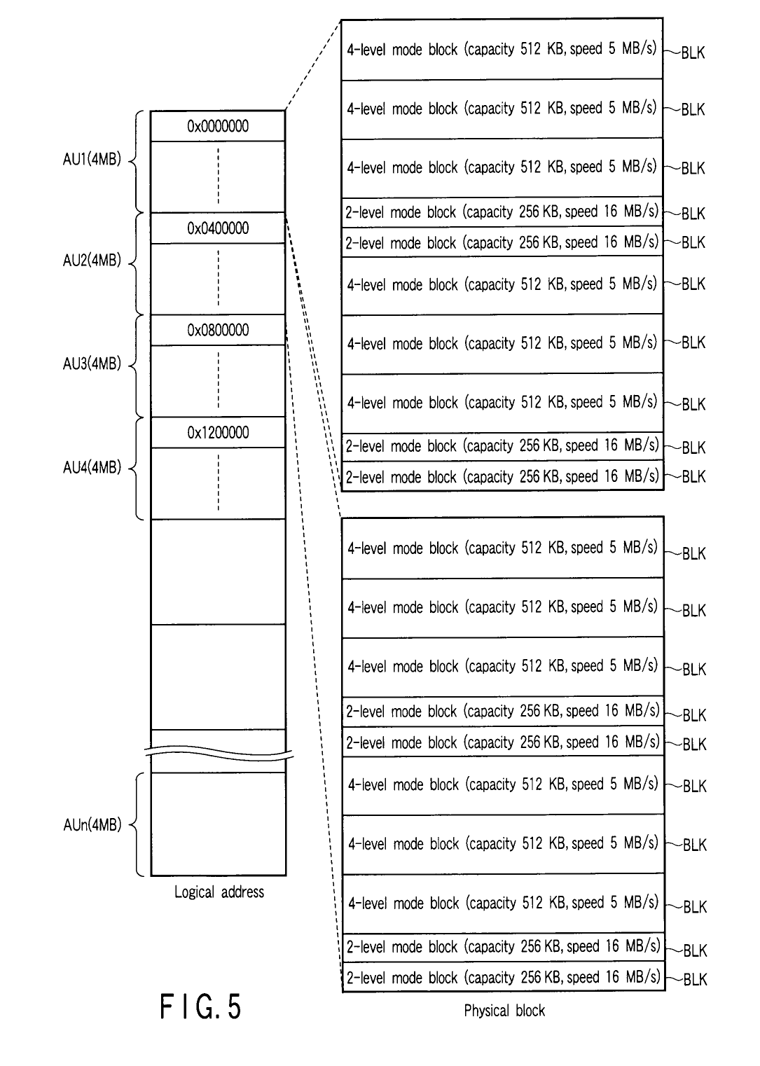

Next, a practical example of the first embodiment will be explained with reference to FIG. 5. FIG. 5 shows a concrete example of the write modes set in the physical blocks. The 2-level mode is used as the first write mode and the 4-level mode is used as the second write mode. An example of the individual parameters of the memory in the first embodiment is as follows:

C1=256 [KB]

C2=512 [KB]

CAU=4 [MB]

WP1=16 [MB/s]

WP2=5 [MB/s]

Suppose the memory system using the memory is requested to realize class 6, that is, to have a write speed exceeding 6 MB/s. In this example, the number of first write mode blocks (2-level mode blocks) is 4 and the number of second write mode blocks (4-level mode blocks) is 6. First, four 2-level mode blocks and six 4-level mode blocks can store 4 MB of data equal to the size of one AU. The time required to write the data in one AU is as follows:

(256 [KB]/16 [MB/s])×4+(512 [KB]/5 [MB/s])×6=0.664 [s]

Therefore, the write speed is 4 MB/0.664 [s]=6.024 [MB/s], which exceeds write speed 6 [MB/s] required by class 6. That is, the memory system can be categorized as class 6.

Consider the storage capacity of the memory system. First, if the number of physical blocks which can be used to write user data is 4 k, the storage capacity of the memory system in writing data into all of the physical blocks in the 2-level mode is 1 GB as shown in the following equation (4):

256 KB×4 k=1 GB (equation 4)

On the other hand, since 40% of all the physical blocks are 2-level mode blocks and 60% of them are 4-level mode blocks, the storage capacity of the memory system in the first embodiment is expressed by the following equation (5):

256 KB×(4/10)+512 KB×(6/10)=1.6 GB (5)

As described above, the storage capacity is 1.6 times that required when all of the physical blocks are written into in the 2-level mode.

In accordance with the above rule, a fixed number of first write mode blocks and that of second write mode blocks are allocated to each AU to store the data in one AU.

If the memory system 2 of the first embodiment is configured using the memory 6 which includes as many physical blocks as are illustrated (4 k physical blocks) and has the write speed (16 [MB/s], 5M [MB/s]) in the example, the storage capacity of the memory system 2 is 1.6 GB, a halfway storage capacity. When such a value is undesirable from the viewpoint of, for example, flow of goods, increasing the number of physical blocks may enable the halfway storage capacity to be adjusted to a round storage capacity, such as 2 GB, while a write speed of 6 [MB/s] is being achieved. Specifically, the number of physical blocks is set to a value obtained by multiplying 4 k by 2 GB/1.6 GB=1.25.

Furthermore, the memory system 2 may be so configured that the speed class of the memory system can be changed by a command from the host 1. The memory system 2 is configured to change the ratio (hereinafter, referred to as the physical block ratio) of the number of 2-level mode blocks to that of 4-level mode blocks allocated to one AU according to an external command. The memory system 2 is configured to cope with any one of a plurality of speed classes by changing the ratio.

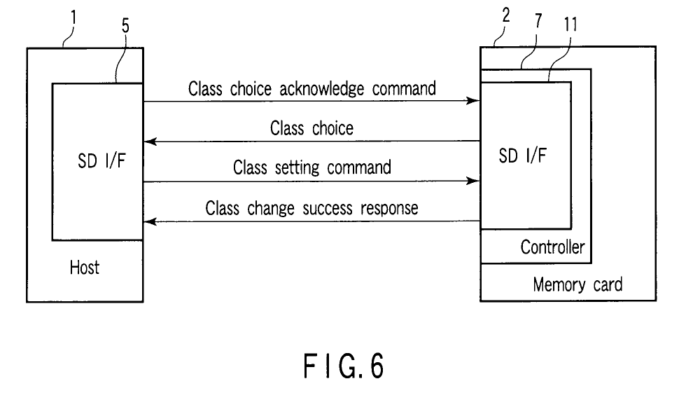

FIG. 6 shows a configuration for setting the speed class of the memory system. As shown in FIG. 6, the SD interface 5 is provided with a class choice acknowledge command. The class choice acknowledge command is supplied from the host 1 and is received by the memory system 2 via an SD interface 7. Receiving the command, the controller 7 transmits data about the speed class settable in itself as a response to the host 1.

When such a memory 6 as has a write speed of WP1=10 [MB/s] in the first write mode and a write speed of WP2=3.5 [MB/] in the second write mode in FIG. 4 is used as a class settable in the memory system 2, the following combinations of classes and storage capacities can be considered:

Setting 1: speed class=class 2, storage capacity=2 GB

Setting 2: speed class=class 4, storage capacity=1.6 GB

Setting 3: speed class=class 6, storage capacity=1 GB

The write speeds for each AU in settings 1, 2, and 3 are 3.5 [MB/s], 4.18 [MB/s], and 10 [MB/s], respectively. Setting 1 can be realized by using all the physical blocks as 4-level mode blocks. Setting 3 can be realized by using all the physical blocks as 2-level mode blocks. Setting 2 can be realized by allocating 4-level mode blocks and 2-level mode blocks in the ratio shown in FIG. 5.

Furthermore, the SD interface 5 is provided with a class setting command. The host 1 selects a desired one from the setting choices (the combinations of feasible speed classes and feasible storage capacities) obtained using the class choice acknowledge command. Then, a class setting command is supplied from the host 1 and is received by the memory system 2 via the SD interface 7. In the argument of the class setting command, the setting identification number requested by the host 1 is shown.

The controller 7 stores the argument in the class setting command into, for example, the system data area. Moreover, the controller 7 changes its setting to a method of allocating physical blocks in the user data area to an AU according to the specified setting and a writing mode. If the setting change is successful, the memory system 2 supplies to the host 2 a response indicating the success of the setting change. From this point on, the memory system 2 writes data in the set class. The class now set in the memory system is read from the memory system 2 into the host 1 by a special command at the time of, for example, initial operation.

This invention is not limited to the speed classes in the explanation. On the basis of the same reasoning, the invention is similarly applied to a memory system where the speed classes are defined by discrete write speeds for a specific range of logical addresses.

In the memory system according to the first embodiment, a part of the physical blocks of the memory system 2 are written into in the first write mode in which the write speed is high but the storage capacity is small and another part of the physical blocks are written into in the second write mode in which the write speed is low but the storage capacity is large. The ratio of the physical blocks written into in the first write mode to those written into in the second write mode is set equally in each of the AUs so as to realize as large a storage capacity as possible, while the required write speed is being achieved.

Accordingly, it is possible to provide a memory system capable of making a high storage capacity compatible with a high write speed.

### Second Embodiment

[1] Configuration of Memory Space

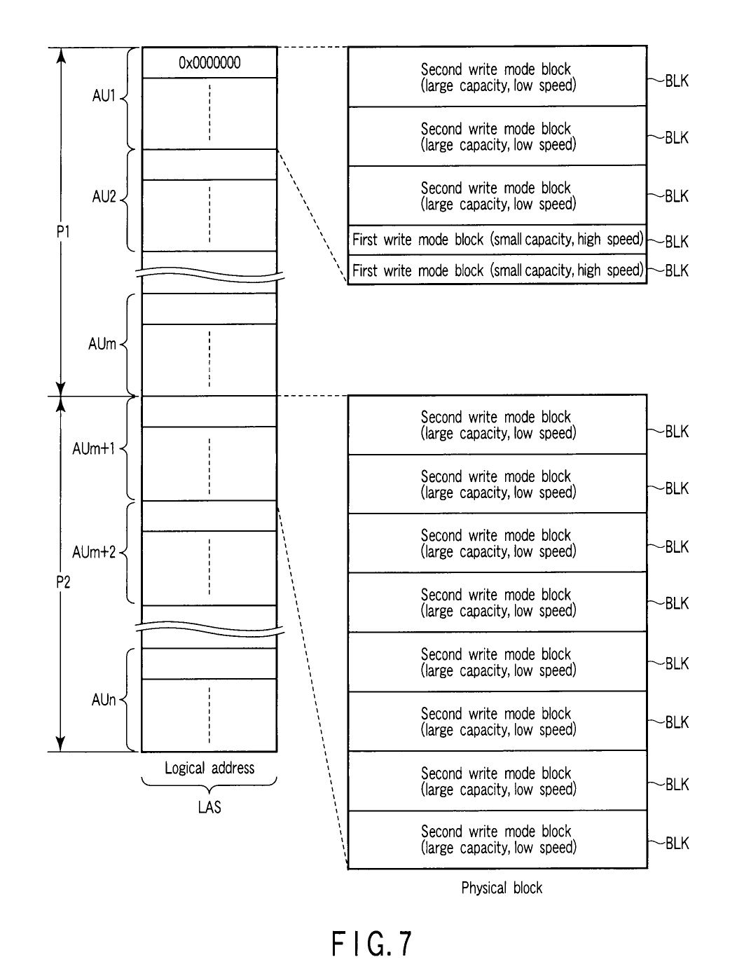

Referring to FIG. 7, a memory space according to a second embodiment of the invention will be explained. FIG. 7 shows an example of the correspondence between the physical blocks and the logical address space in the second embodiment.

As shown in FIG. 7, one logical address space LAS, which corresponds to a memory area 31, is composed of a plurality of logical address groups (AU). In the second embodiment, the logical address space is divided into a plurality of partitions (logical areas) P1, P2. A storage capacity in a specific range is set in each of the partitions P1, P2. A different speed class is set in each of the partitions P1, P2. The first or second write mode blocks are allocated to the AU in each partition on the basis of expression 2 (or 3) so that the set storage capacity may be satisfied, while the write speed required by the speed class in each of the partitions P1, P2 is being achieved. Accordingly, it is possible to provide a memory system capable of making a high storage capacity compatible with a high write speed more efficiently.

In the second embodiment, when a plurality of partitions are set, the begin address and end address of each partition are stored as logical area information into, for example, the system data area of the flash memory 6 in the memory card 2. The logical area information is written by, for example, a special write command and is read by an ordinary read command.

When a plurality of speed classes are mixed in a single memory card (memory system), the controller 7 of the memory card 2 shown in FIG. 1 has a register (not shown) for holding a plurality of class specifications included in its SD interface 11. This enables the host 1 to read the class specification of each of the partitions P1, P2. Accordingly, the memory system of the second embodiment can be provided.

[2] Operation

An example of the operation of acknowledging the partitions of the memory card 2 in the second embodiment will be explained with reference to FIG. 1.

First, after the memory card 2 is connected via the SD interfaces 5, 11 to the host 1, various initial operation commands are issued, thereby initializing the memory card 1. Then, the MPU 12 reads the logical area information from the system data area in the flash memory 6 and informs the host 1 of the logical area information via the interfaces 5, 11.

This causes the host 1 to acknowledge the begin and end addresses of each of the partitions P1, P2, storage capacities, and speed classes set in the memory card 2.

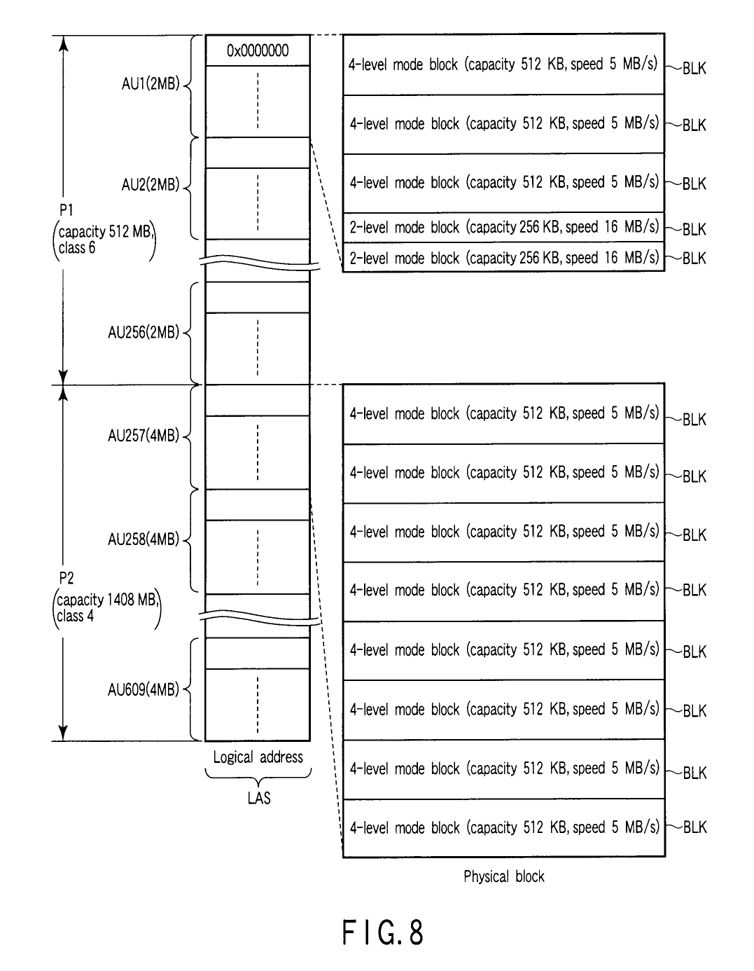

Then, referring to FIG. 8, the write operation of the memory card 2 in the second embodiment will be explained in further detail. FIG. 8 shows a concrete example of the correspondence between the physical blocks and the write modes set in the physical blocks in the logical address space divided into two partitions P1, P2. In the second embodiment, too, the 2-level mode is used as a first write mode and the 4-level mode is used as a second write mode. The individual parameters C1, C2, WP1, and WP2 of the memory system in the second embodiment are the same as those in the first embodiment.

In the memory system of the second embodiment, two partitions P1 and P2 are provided in one logical address space LAS. The storage capacity of one partition (first logical area) P1 is set to 512 MB. The storage capacity of the other partition (second logical area) P2 is set to 1408 MB. Suppose partition P1 is required to realize class 6, that is, its write speed is required to exceed 6 [MB/s], and partition P2 is required to realize class 4, that is, its write speed is required to exceed 4 [MB/s].

When the communication between the host 1 and memory card 2 is determined by the SD interfaces 5, 11, the storage capacity of one AU is determined by the card storage capacity. As in the second embodiment, when the logical address space is divided into a plurality of partitions, suppose the storage capacity of one AU is determined by the partition storage capacity. In the second embodiment, to simplify the explanation, let the storage capacity of one AU be 4 MB for a partition whose storage capacity is 1 GB or more and be 2 MB for a partition whose storage capacity is smaller than 1 GB. Accordingly, in the example of FIG. 8, the storage capacity of one AU of partition P1 is 2 MB and the storage capacity of one AU of partition P2 is 4 MB. As in the first embodiment, the explanation below is based on the assumption that expression 1 is satisfied for one AU in each of the partitions.

In partition P1 of the memory system, since the write speed is required to exceed 6 MB/s, the number of 2-level mode blocks is 2 and the number of 4-level mode blocks is 4 in the example on the basis of expression 1. This makes it possible to store 2 MB of data, almost the same size as that of one AU in partition P1. On the basis of expression 2 (or 3), the time required to write the data in one AU is as follows:

(256 [KB]/16 [MB/s])×2+(512 [KB]/5 [MB/s])×3=0.332 [s]

Accordingly, the write speed is 2 MB/0.332 s=6.024 [MB/s], which exceeds a write speed of 6 [MB/s] required by class 6.

On the other hand, in partition P2, since the write speed is required to exceed 4 MB/s, the number of 4-level mode blocks is 8 in the example. This makes it possible to store 4 MB of data, the same size as that of one AU in partition P2. The time required to write the data in one AU is as follows:

(512 [KB]/5 [MB/s])×8=0.819 [s]

Accordingly, the write speed is 4 MB/0.819 s=4.88 [MB/s], which exceeds a write speed of 4 [MB/s] required by class 4.

That is, in the memory system, partition P1 can be categorized as class 6 and partition P2 can be categorized as class 4. In the example of FIG. 8, the number of blocks in partition P1 is 5×256 AUs=1280, the number of blocks in partition P2 is 8×352 Aus=2816, and therefore the total number of blocks in the memory card 2 is 4096.

As described above, a plurality of partitions in which different speed classes are defined are provided in a single logical address space, thereby making it possible to provide a memory system capable of making a high storage capacity compatible with a high write speed more efficiently. For example, a partition in which the storage capacity is set large and the write speed is set low is applied to the operation of recording video data for a long time at a low bit rate. A partition in which the storage capacity is set small and the write speed is set high is applied to the operation of recording video data or image data at a high bit rate. Alternatively, a partition in which the storage capacity is set small and the write speed is set low may be applied to the operation of recording the data of a small size file, such as a document file. A partition in which the storage capacity is set large and the write speed is set high may be applied to the operation of recording the data of a large size file, such as an audio file.

Furthermore, the memory card 2 may be configured to be capable of changing the speed class and storage capacity set in each partition according to a command from the host 1. The memory card 2 is configured to change the physical block configuration allocated to one AU in each partition according to an external command or to change the ratio of the numbers of AUs allocated to one partition. This enables the memory system 2 to deal with the setting of a plurality of speed classes and a plurality of partitions.

Hereinafter, a configuration for setting a speed class and a storage capacity in each partition in the memory system of the second embodiment will be explained using FIG. 6.

In the second embodiment, the SD interface 5 is provided with a capacity/class choice acknowledge command in place of the class choice acknowledge command in the first embodiment. The controller 7 receives the command from the host 1. Then, the controller 7 transmits data about the speed class and storage capacity of each partition that can be set by itself as a response to the host 1.

For example, when the memory 6 in which speed WP1 in the first write mode is 10 [MB/s] and speed WP2 in the second write mode is 3.5 [MB/s] is used as a class settable in the memory card 2, the following combinations of classes and storage capacities can be considered:

Setting 1: the number of partitions=1, speed class=class 4, storage capacity=2 GB

Setting 2: the number of partitions=1, speed class=class 6, storage capacity=1.6 GB

Setting 3: the number of partitions=2
partition 1 . . . speed class=class 6, storage capacity=1 GB
partition 2 . . . speed class=class 4, storage capacity=768 MB

Setting 4: the number of partitions=2
partition 1 . . . speed class=class 6, storage capacity=512 MB
partition 2 . . . speed class=class 4, storage capacity=1408 MB

Setting 5: the number of partitions=2
partition 1 . . . speed class=class 6, storage capacity=256 MB
partition 2 . . . speed class=class 4, storage capacity=1728 MB

The write speed for each AU in setting 1 is 4.08 [MB/s]. Setting 1 can be realized by allocating 4-level mode blocks and 2-level mode blocks in the ratio shown in FIG. 5. The write speed for each AU in setting 2 is 6.68 [MB/s]. Setting 2 can be realized by dividing the physical blocks into two 4-level mode blocks and twelve 2-level mode blocks.

The write speed for each AU (4 MB) in partition 1 in setting 3 is 6.66 [MB/s]. In each Au in partition 1, setting 3 can be realized by dividing the physical blocks into two 4-level mode blocks and twelve 2-level mode blocks. The write speed for each AU (2 MB) in partition 2 is 5.06 [MB/s]. In each AU in partition 2, setting 3 can be realized by dividing the physical blocks into three 4-level mode blocks and two 2-level mode blocks.

The write speed for each AU (2 MB) in partition 1 in setting 4 and setting 5 is 6.66 [MB/s]. The write speed for each AU (4 MB) in partition 2 is 4.08 [MB/s]. Setting 4 and setting 5 can be realized by dividing the physical blocks into one 4-level mode block and six 2-level mode blocks. As for each AU in partition 2, setting 4 and setting 5 can be realized by dividing the physical blocks into six 4-level mode blocks and four 2-level mode blocks.

Furthermore, in the second embodiment, the SD interface 5 is provided with a capacity/class setting command in place of the class setting command described in the first embodiment. The host 1 selects a desired one from the setting choices obtained using a capacity/class choice acknowledge command. Then, a capacity/class setting command is supplied from the host 1 and is received by the memory system 2 via the SD interface 7. In the argument of the capacity/class setting command, the setting identification number requested by the host 1 is shown.

The controller 7 stores the argument into, for example, the system data area. Moreover, the controller 7 allocates the physical blocks in the user data area to the AU according to the specified setting and changes its setting to the specified number of partitions, specified storage capacity, and specified writing method. After the setting change, the memory card 2 supplies to the host 1 a response indicating the success of the setting change. From this point on, the memory system 2 writes data in the set class into the block corresponding to the AU in the set partition. The partition and class now set in the memory system are read from the memory card 2 into the host 1 by a special command at the time of, for example, initialization.

The invention is not limited to the number of partitions and the storage capacity of the partitions in the above explanation. For instance, while in the second embodiment, 2-level mode blocks and 4-level mode blocks are mixed, they may be further mixed with 6-level mode blocks or 8-level mode blocks and the resulting mixture be allocated to each AU, provided that the speed class defined in each partition is satisfied. Alternatively, only 2-level mode blocks may be allocated to each AU in a partition and only 4-level mode blocks be allocated to each AU in another partition.

Furthermore, the invention is not restricted to the definition of speed classes in the above explanation. On the basis of the same reasoning, the invention is similarly applied to a memory system where the speed classes are defined by discrete write speeds for a specific range of logical addresses.

In the memory system of the second embodiment, a plurality of partitions are set in a single logical address space and different speed classes are defined in the individual partitions. Moreover, a part of the physical blocks of the memory system 2 are written into in the first write mode in which the write speed is high but the storage capacity is small and another part of the physical blocks are written into in the second write mode in which the write speed is low but the storage capacity is large. The physical blocks are allocated to the AUs in each partition in such a manner that the ratio of the physical blocks written into in the first write mode and those written into in the second write mode is made different so as to satisfy the defined speed class. Accordingly, it is possible to provide a memory system capable of making a high storage capacity compatible with a high write speed more efficiently.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory system comprising:
a nonvolatile semiconductor memory which includes a plurality of storage areas each composed of a group of a plurality of storage elements, stores one or more than one bit of data into each of the plurality of storage elements and selects either a first write mode in which n (n is a natural number) bits of data are stored into each of the plurality of storage elements or a second write mode in which n+1 or more bits of data are stored into each of the plurality of storage elements for each of the plurality of storage areas; and
a controller which instructs the nonvolatile semiconductor memory to store data, for each of a plurality of logical address groups each composed of a plurality of logical addresses belonging to a specific range, by writing a part of the data allocated with the logical addresses included in the logical address group into a preset first number of the plurality of storage areas in the first write mode and writing another part of the data into a preset second number of storage areas in the plurality of storage areas in the second write mode.

2. The memory system according to claim 1, wherein the nonvolatile semiconductor memory further carries out a first operation using a first combination of the first number and the second number or a second operation using a second combination of the first number and the second number;
outputs information about the performance based on the first operation and that based on the second operation; and
switches of switching between the first operation and the second operation under external control.

3. The memory system according to claim 1, wherein the first number and the second number are set so that the sum of the capacity of the plurality of storage areas written into in the first write mode and the capacity of the plurality of storage areas written into in the second write mode is greater than or equal to a specific storage capacity previously defined for the logical address group.

4. The memory system according to claim 3, wherein the first number and the second number are set so that an average write time required to write the data allocated to the logical addresses included in the logical address group is shorter than a specific preset write time.

5. The memory system according to claim 4, wherein, of the first number and the second number, the first number is set so as to be as large as possible.

6. The memory system according to claim 1, wherein the write speed in the first write mode is higher than the write speed in the second write mode.

7. The memory system according to claim 1, wherein the storage capacity of the logical address group is defined by the storage capacity of the nonvolatile semiconductor memory.

8. The memory system according to claim 1, wherein the controller includes an SD interface.

9. The memory system according to claim 1, wherein the nonvolatile semiconductor memory is a NAND flash memory.

10. A memory system comprising:
a nonvolatile semiconductor memory which includes a plurality of storage areas each composed of a group of a plurality of storage elements, stores one or more than one bit of data into each of the plurality of storage elements and selects either a first write mode in which n (n is a natural number) bits of data are stored into each of the plurality of storage elements or a second write mode in which n+1 or more bits of data are stored into each of the plurality of storage elements for each of the plurality of storage areas; and
a controller which instructs the nonvolatile semiconductor memory to store data, for each of a plurality of logical address groups each composed of a plurality of logical addresses belonging to a specific range, by writing a part of the data allocated with the logical addresses included in the logical address group into a preset first number of the plurality of storage areas in the first write mode and writing another part of the data into a preset second number of the plurality of storage areas in the second write mode,
wherein a first logical area with a first storage capacity and a second logical area with a second storage capacity are set, and
the plurality of storage areas are allocated to the logical address group in the first logical area and the logical address group in the second logical area in such a manner that the first number or the second number differs between the logical address group in the first logical area and that in the second logical area.

11. The memory system according to claim 10, wherein the first and second logical areas are set in one logical address space composed of the plurality of logical address groups.

12. The memory system according to claim 10, wherein the nonvolatile semiconductor memory further carries out a first operation using a first combination of the first number and the second number or a second operation using a second combination of the first number and the second number,
sets the first storage capacity and the second storage capacity,
defines one of the first and second operations for the first logical area and further defining the other of the first and second operations for the second logical area,
outputs information about the first storage capacity and second storage capacity and about the performance based on the operation defined for the first logical area and that based on the operation defined for the second logical area;
changes the first storage capacity or second storage capacity under external control; and
switches between the operation defined for the first logical area and the operation defined for the second logical area.

13. The memory system according to claim 10, wherein the nonvolatile semiconductor memory further outputs the begin address and end address of each of the first and second logical areas stored in the nonvolatile semiconductor memory.

14. The memory system according to claim 10, wherein the first number and the second number are set so that the sum of the capacity of the plurality of storage areas written into in the first write mode and the capacity of the plurality of storage areas written into in the second write mode is greater than or equal to a specific storage capacity previously defined for the logical address group.

15. The memory system according to claim 14, wherein the first number and the second number are set so that an average write time required to write the data allocated to the logical addresses included in the logical address group is shorter than a specific preset write time.

16. The memory system according to claim 15, wherein, of the first number and the second number, the first number is set so as to be as large as possible.

17. The memory system according to claim 10, wherein the write speed in the first write mode is higher than the write speed in the second write mode.

18. The memory system according to claim 10, wherein the storage capacity of the logical address group included in the first logical area is defined on the basis of the first storage capacity and the storage capacity of the logical address group included in the second logical area is defined on the basis of the second storage capacity.

19. The memory system according to claim 10, wherein the controller includes an SD interface.

20. The memory system according to claim 10, wherein the nonvolatile semiconductor memory is a NAND flash memory.
